(19) United States
(12) Patent Application Publication
(10) Pub. No.: US 2013/0085821 A1
(43) Pub. Date: Apr. 4, 2013

(54) Strategy-Resistant Referral Reward Distribution

(71) Applicants: John R. Douceur, Bellevue, WA (US); Thomas Moscibroda, Beijing (CN); Neal Freeland, Seattle, WA (US); Bruno S. Caiado, Issaquah, WA (US)

(72) Inventors: John R. Douceur, Bellevue, WA (US); Thomas Moscibroda, Beijing (CN); Neal Freeland, Seattle, WA (US); Bruno S. Caiado, Issaquah, WA (US)

(73) Assignee: Microsoft Corporation, Redmond, WA (US)

(21) Appl. No.: 13/249,049

(22) Filed: Sep. 29, 2011

(51) Int. Cl. G06Q 30/02

(52) U.S. Cl. 705/14.4; 705/1.1; 705/39

(57) ABSTRACT

In a participatory system, a reward is distributed to participants based on their contributions to the system and the contributions of direct and indirect referrals of the participant (descendant referrals). A convex function is applied to the effective contribution of each participant to determine the weighted contribution of the participant, and the participant's reward is based on the participant's weighted contribution less the weighted contributions of child participants referred by the participant.

### BACKGROUND

Refer-a-friend programs seek to motivate participants in a group to encourage their acquaintances to join the group. When the benefit of each new member exceeds the cost of motivating the referral, refer-a-friend programs are inherently beneficial to the agency running the group. However, in some scenarios, the benefit of each new member may vary, and this benefit might not even be known at the time of the referral. Thus, a conventional refer-a-friend program might yield referrals that have an unfavorable cost/benefit trade-off to the agency. In addition, if a participant's benefit from a referral is greater than the base cost of joining the group, a participant might strategically create multiple identities, send a referral to each identity, and have each identity join the group, thereby gaining value at the expense of the agency. Such multiple-identity attacks are particularly problematic for online systems, where forged identities are easy to create and difficult to detect. Furthermore, conventional referral programs only provide incentive for direct referrals; they do not incentivize a participant to refer other participants who might then refer other participants. Thus, even though referring further referrers is beneficial to the group, this behavior is not encouraged by these types of programs.

### SUMMARY

This disclosure describes techniques for incentivizing and rewarding participants of a participatory system such as an online service or web site in which participants solicit or refer other participants. The techniques involve identifying participant subsets that include the participant and any descendant referrals of the participant. A participant's effective contribution is then identified based on the collective contributions of the participant's subset. Based on the participant's effective contribution, a weighted net contribution of the participant is calculated and rewards are distributed deterministically according to the weighted net contributions of the individual participants. The weighted net contribution is calculated in such a way that the size of the reward to any given subset of participants is determined by the quantified contributions of those participants.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a diagram illustrating an environment in which participants are rewarded for their contributions and for referring other participants.

FIG. 2 is a diagram of a contribution/referral tree that represents participants and their referrals in a directed graph structure.

FIG. 3 is a flow diagram illustrating an example method of rewarding a participant based on their contributions and the contributions of other participants who have been referred by the participant.

FIG. 4 is a data flow diagram illustrating an example calculation of a participant's weighted net contribution.

FIG. 5 is a flow diagram that further illustrates an example calculation of weighted net contribution for a plurality of participants.

FIGS. 6-9 illustrate exemplary participant/referral trees for the purpose of explaining the calculations described with reference to FIGS. 4 and 5.

### DETAILED DESCRIPTION

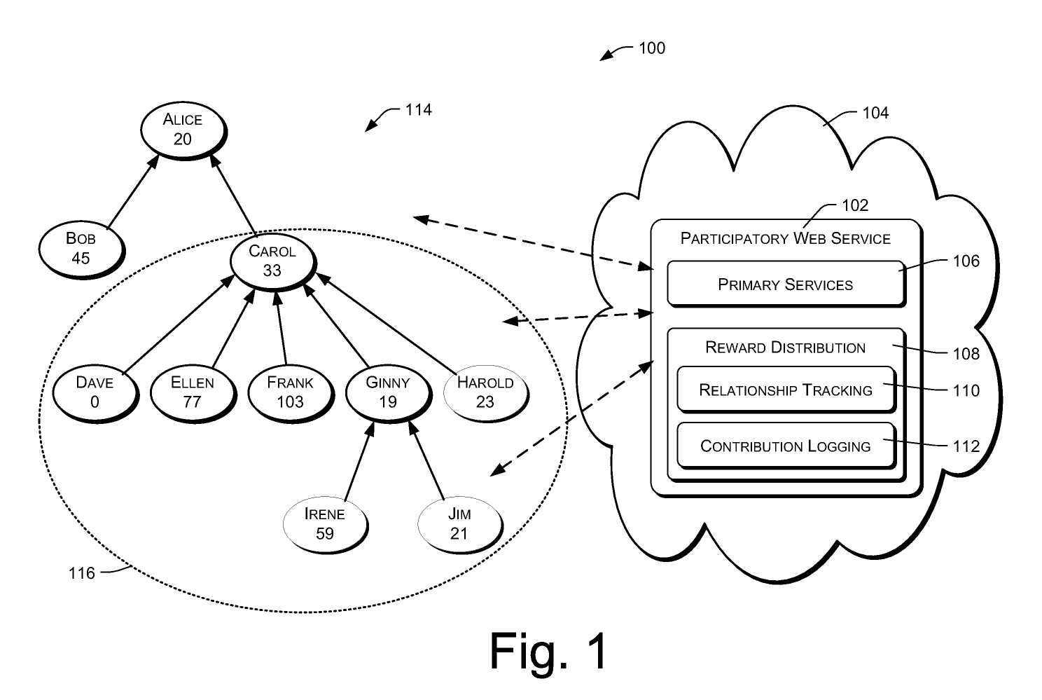

FIG. 1 illustrates an environment 100 that includes a participatory web service 102 that is accessible by multiple participants through a network 104, which may comprise the Internet or some other type of network. The participatory web service 102 may be any type of service for which additional participants are desired. For example, the web service 102 may be an ad-based web service that seeks to increase revenues by increasing traffic to its web site. News sites, dating sites, blogging sites, web search sites, and so forth may be specific examples of Internet sites for which a site sponsor or other executive entity may wish to encourage use, membership, and participation.

The web service 102 may also comprise a service that accepts contributions of various types from participants, such as various types of crowd-sourcing services. For example, the web service may be a knowledge base to which users contribute, or a public service site that seeks to offload small computing tasks to willing participants.

Various other services and programs may also utilize the techniques described herein, including subscription services, membership programs, and other programs in which participants pay to utilize services.

In order to promote and encourage participation in the web service 102, the web service may offer rewards. Rewards may include anything that potential participants perceive as having tangible or intangible value, such as financial compensation, credits, monetary payments, points, badges, titles, goods, services, gifts, donations to charitable causes, ownership shares, revenue shares, and so forth. The sizes of the rewards are determined in a fashion that is designed to encourage user participation, and to also encourage referrals of other participating users. Furthermore, the sizes of rewards for individual participants are calculated in such a way as to resist strategies that might otherwise be used to manipulate or “game” the system to gain undeserved advantages or rewards.

The participatory web service 102 may have a primary services component 106 that provides or implements the primary services and/or functionality of the web service 102. The primary services component 106 may comprise one or more servers and associated infrastructure, customized for the particular functionality of the web service 102.

The participatory web service 102 may also include membership and reward distribution components or functionality 108 for keeping track of users, their contributions, and their referrals. The membership and reward distribution components may include a referral or relationship tracking component 110 and a contribution logging component 112. The relationship tracking component 110 allows users to refer other users, and keeps track of which users have referred which other users. The contribution logging component 112 quantifies and keeps track of contributions by individual users.

Contributions by individual participants may be quantified in terms various parameters, such as page views, numbers of submitted searches, contributed CPU cycles, words contributed, and so forth. Contributions may be in the form of actual submissions or services. Contribution may alternatively be measured as the quantity of services consumed by the participant from the web service 102, or the amount the services are used by the participant. The terms “participation” and “contribution” will be used interchangeably in the following discussion to indicate a quantified measure of desired participant behavior.

The left side of FIG. 1 illustrates an example of relationships between a set of participants 114 of the web service 102. The participants 114 are illustrated in a directed graph, referred to as a participant/referral tree, in which nodes represent individual participants and edges between the nodes represent relationships between the participants. As an example, an edge leading from Bob to Alice indicates that Bob was referred by Alice.

The relationships between participants form various participant subtrees or subsets, with each subset having a single head. For example, a subset 116 is formed by the participants within the dotted oval. The participant Carol is at the head of the subset 116, and the subset 116 may be referred to as Carol's subset. The subset 116 includes Carol, Dave, Ellen, Frank, Ginny, Harold, Irene, and Jim. As another example, a subset is formed by Ginny, Irene, and Jim, with Ginny at the head. Each participant has a corresponding subset, of which he or she is the head. Participants other than the head are described as descendants of the head participant.

Formally, a participant's subset is the set of participants containing the participant, all other participants referred by the participant, all participants referred by those participants, and so on, such that each participant subset includes all participants referred by all members of the subset. In some contexts, a referring participant might be referred to as a parent, and those referred by the parent might be referred to as children of the parent.

When a new person joins the service 102, they may do so as either an original user or a referred user. For example, people might sign up to the service 102 by visiting a web site that records information or installs an application. If someone visits the site on their own, they join as a child of the system root node (not shown) that represents the executive or administrative entity associated with the service 102. Once a member, a participant is able to send solicitations, perhaps in the form of coded email links, to friends and associates. Anyone who follows the coded link to the web site will join as a child of the participant who sent the link.

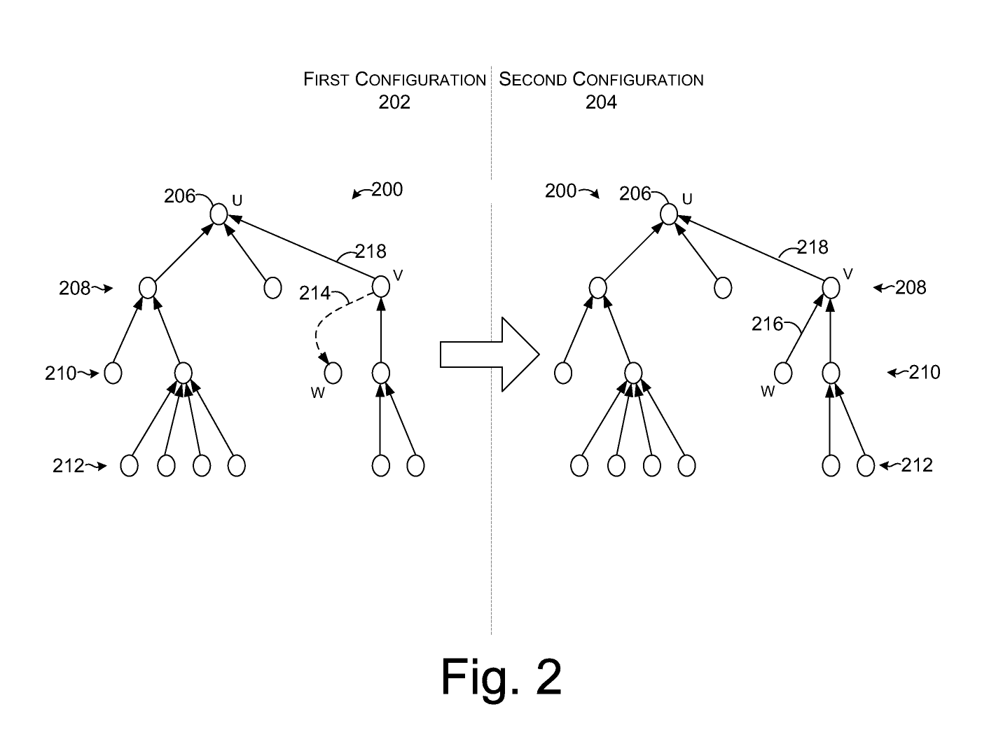

FIG. 2 illustrates the impact of a referral and how it may be tracked by a graph structure such as that of FIG. 1. FIG. 2 shows a directed participant/referral tree 200 in a first tree configuration 202 on the left and a second or subsequent tree configuration 204 on the right. In this example, the tree 200 includes a root node “u” generally at 206 with descendant child nodes represented horizontally across the Figure at 208. Subsequent descendant nodes (i.e., grandchildren and great-grandchildren) are shown horizontally across the Figure at 210 and 212, respectively. In the first tree configuration 202, a child node or participant “v” solicits a new participant “w” for the tree as indicated by dashed line 214. In the ensuing solicitation tree structure configuration 204, node w is added to the tree 200 as a child of v as indicated by solid line 216.

In practice, solicitations may occur in numerous ways. For instance, participant v can send a recommendation email to friend w containing a link that leads to a sign-up page. When clicking on this link and signing up as a new participant of the networked system, the URL indicates v as the solicitor of w. In another case, at the time of joining the network, a new participant may indicate its solicitor by providing its (e.g., the solicitor's) name or identification number (e.g., systems with off-line sign-up procedure). In this case, w would list v as w's solicitor when completing a sign-up procedure. In still another example, depending on the nature of the service 102, it is also conceivable that the solicitor of a specific node changes during the course of the system's lifetime.

As mentioned above, each member's contribution can be monitored, measured, and quantified. Referring again to FIG. 1, a number is associated with each participant node, corresponding to a measure of the degree of contribution by that participant. Alice, for example, shows a contribution of 20, while Bob is shown as having a contribution of 45.

Contribution can be measured utilizing one or more criteria. An example of such criteria can include an amount of computing time (e.g. in CPU cycles) offered to a distributed computing or grid computing project. Another example can be the number of software updates/products installed from a software company. A further example can be the amount, number, or frequency of services purchased and/or consumed from the service 102, such as the number of keyword searches performed or the number of other service features used. A further example can be the number of recommendations submitted to a networked recommendation system. Another example can be the number of pictures tagged with keywords in a networked system that classifies picture-databases. A further example can be the amount of storage provided to a distributed, decentralized file-storage system. Still another example can be the number of games played on an online game site or in a massive multiplayer games setting. A still further example can be the number of files or blocks uploaded to a P2P system. The skilled artisan should recognize still other examples.

Regardless of what exactly constitutes contribution in any given system, exemplary implementations can formally express the contribution as a number that becomes larger as the participation in and/or contribution to the system gets larger.

In a system without measurable contribution, or when soliciting new participants constitutes the primary contribution (as in certain marketing schemes or social networks), the contribution can also be set to be uniform (e.g., equal to 1) over all participants in the participant/referral tree.

As mentioned above, there may be many original participants who have not been referred by other participants. For purposes of discussion and analysis, these participants are considered to be children of a single parent or root node corresponding to the executive entity of the web service 102.

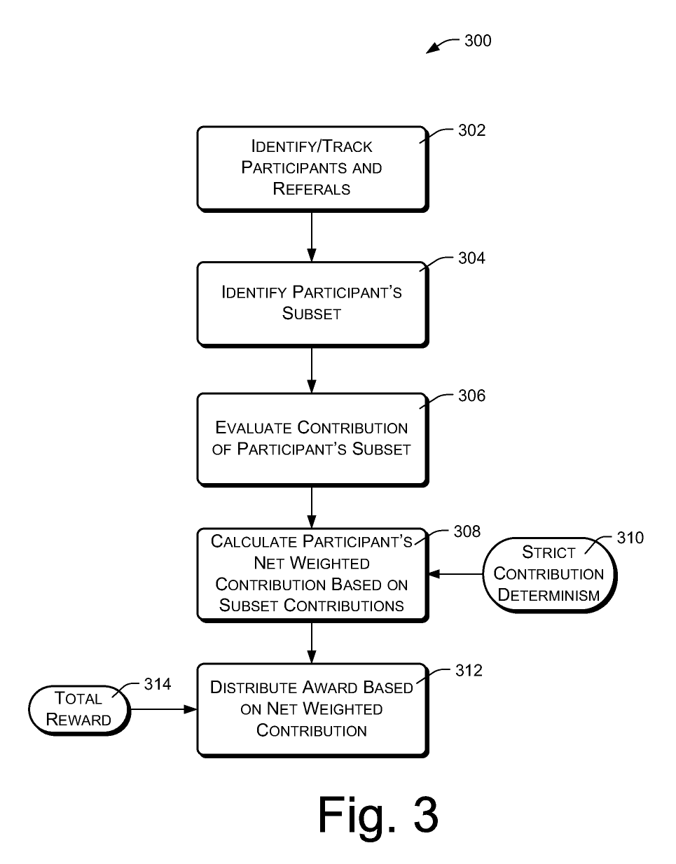

FIG. 3 illustrates an example method 300 of promoting a web-based service in an environment such as illustrated by FIG. 1. The actions of FIG. 3 are repeated for each of multiple participants 114. For purposes of discussion, the method 300 will be described as acting with respect to a single “current” participant.

An action 302 comprises identifying and/or tracking the current participant, contributions by the current participant, and referrals made by the current participant, thereby allowing the logical representation of a participant base in a directed graph such as that illustrated in FIG. 1.

An action 304 comprises identifying a participant subset corresponding to the current participant. As mentioned above, the current participant's subset includes the current participant and all descendents of the current participant. Stated alternatively, a participant's subset includes the participant and all other participants referred by any members of the subset.

An action 306 comprises evaluating and/or quantifying the contribution of the participant's subset. In the described embodiment, this comprises quantifying the contribution of each participant in the current participant's subset.

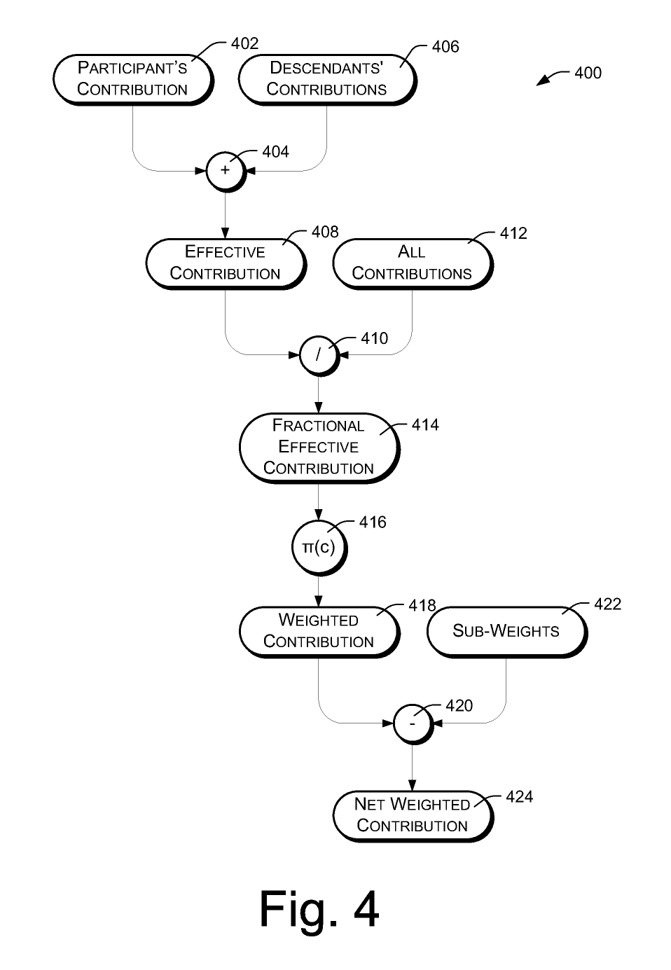

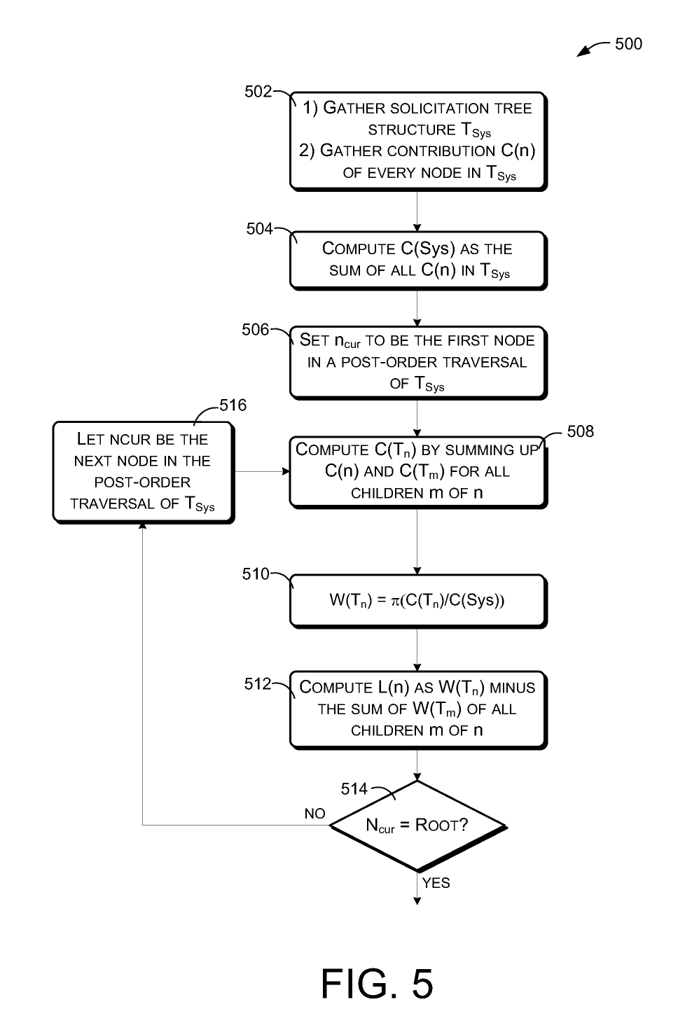

An action 308 comprises calculating the weighted net contribution of the current participant. This action is subject to a property 310 that is referred to herein as the property of strict contribution determinism: for any subset of participants that includes all participants referred by members of the subset, the collective reward received by all participants in the subset is determined strictly by the contributions of those participants. A specific example of a technique for calculating weighted net contribution will be described below, with reference to FIGS. 4 and 5.

An action 312 comprises distributing awards to participants, where the sizes or portions of the rewards are calculated deterministically, based on a total available reward 314 and on the calculated weighted net contribution of each participant. In certain embodiments, the size of the total reward 314 for any particular participant is proportional to the participant's weighted net contribution. In some embodiments, the reward for a participant may be calculated by multiplying the total reward 314 by the participant's weighted net contribution. A participant's reward includes portions for both direct contributions and for contributions by referred descendants of the participant.

As will be described in more detail below, the action 308 of calculating a participant's weighted net contribution may be based on a convex function π(c). An exponential function is an example of a convex function. In the described embodiment, the function comprises a square function: π(c)=c². This particular function has the properties that an input of zero yields an output of zero, and an input of one yields an output of one. These two properties are not necessary, but they simplify the use of the function.

Generally, the weighted net contribution of a participant can be calculated as follows. A weight or weighted contribution W(n)=π(C(n)/C(Sys)), is computed for each node n in a participant/referral tree, where C(n) comprises the effective contribution of the node n, and C(Sys) is the summed contribution of all nodes. Thus, W(n) is the function π(c) applied to the node n's proportional contribution. For example, if the sum of all system contributions is 40 and a participant n's effective contribution is 5, then n's proportional or fractional contribution is 5/40=⅛ and its weighted contribution W(n) is W(n)=π(⅛). Stated alternatively, the weight or weighted contribution W(S) of any subset S is defined as π(c) applied to this subset's proportional contribution. For example, the weight of a subset S consisting of three nodes with direct contributions 3, 4, and 7 is W(S)=π((3+4+7)/40)=π(7/20).

An expected value or weighted net contribution L(n) is then calculated for each node n. L(n) is calculated as the weight of the subset rooted at n minus the weights of subsets corresponding to all children of n.

FIG. 4 illustrates an example method 400 for calculating the weighted net contribution L(n) of an individual participant n. The participant's individual or direct contribution 402 is summed at 404 with the contributions 406 of all descendents of the participant. Thus, the action 404 comprises summing the direct contributions of each member of the participant's subset. This results in what is referred to herein as the participant's effective contribution 408.

At 410, the effective contribution 408 of the participant is divided by the summed contributions 412 of multiple participants, which will typically comprise all participants of the service 102. This yields the fractional or proportional effective contribution 414 of the participant. Note that the action 414 may be omitted in certain embodiments, and subsequent actions may act upon the effective contribution 408 rather than on the fractional effective contribution 414.

At 416, the convex function π(c) is applied to the effective contribution 408 or to the fractional effective contribution 414 to yield the weight or weighted contribution 418 of the participant.

At 420, the weighted contributions 422 of any child participants of the current participant are subtracted from the participant's weighted contribution 418 to yield the net weight or weighted net contribution 424 of the participant.

As described above, the size of the reward to an individual participant may be based on the weighted net contribution of the participant, and may in certain embodiments be proportional to the participant's weighted net contribution. Because of the way the weighted net contribution is calculated, rewards are granted based primarily on the contributions of a system's users, avoiding the situation in which rewards might be granted for referrals that end up exhibiting no beneficial contribution. Rather, a participant is rewarded based on the amount of contribution of referred users. Also, a participant is rewarded for referring participants who refer other participants—assuming that all of the participants actually contribute.

Furthermore, because of the property of strict contribution determinism exhibited by the technique of FIG. 4, this reward system resists multiple-identity attacks. Specifically, a participant gains no benefit from forging multiple identities and dividing up its contributions among those entities. The total reward received by all such identities would exactly equal the reward received by crediting the cumulative contributions to the single original participant.

Additionally, the described techniques do not provide an incentive for participants to bypass referrers. The concern here is that prospective participants might react to referrals by ignoring the referrer and instead joining the system as unreferred participants. If this were the case, participants might become reluctant to refer, because they might assume that people will join as unreferred participants and thus not provide any reward to the referrer. However, the property of strict contribution determinism is sufficient to prevent participants from benefitting by bypassing their referrers.

FIG. 5 illustrates a further example technique 500 for calculating weighted net contributions for a plurality of participants. At block 502, the technique gathers a participant/referral tree structure (T_{sys}). The technique also gathers or tracks the contribution C(n) of every node in T_{sys}. An action 504 comprises computing the total contribution C(Sys) of the tree by summing up all contributions C(n) of the individual participants in T_{sys}.

Beginning at block 506, this implementation executes a post-order traversal of the participant/referral tree. That is, all nodes are visited one by one recursively in the order left-most subset, second left-most subset, . . . , right-most subset, node. At each step of this traversal in which a node n is considered, the weight of n's subset W(T₁) and the weighted net contribution L(n) are computed.

At block 508 for a node n, the technique computes the total contribution C(Tₙ) of n's subset Tₙ. Note that due to the post-order traversal, all values C(m) for every descendent m of n are already known to the algorithm. At block 510, the technique computes the weighted contribution W(Tₙ) of n's subset by applying the function π(c) to the ratio C(Tₙ)/C(Sys), where C(Sys) denotes the total contribution in the system, i.e., W(Tₙ)=π(C(Tₙ)/C(Sys)).

At block 512 the technique computes the weighted net contribution L(n) of n by taking the subset weight W(Tₙ) and subtracting from it the weighted contributions of all child participants of the current participant. This can be expressed as:

L(n)=W(Tₙ)−Σ_{all children m of n} W(Tₘ)

If a node has no children, its weighted net contribution L(n) is simply its weighted contribution; that is, L(n)=W(n).

Note that due to the post-order traversal, all values W(Tₘ) are already known to the algorithm.

At 514 the technique queries whether n_{cur} is the root of the solicitation tree. In an instance where n_{cur} is not the root (i.e., “no” at block 514), then the process proceeds to block 516 to continue the post-order traversal. In an instance where the n_{cur} is the root (i.e., “yes” at block 514) then the technique returns the calculated weighted net contribution of the individual participants to the method of FIG. 3—reaching the root indicates that the process is complete due to the nature of the post-order traversal.

At block 516, the technique proceeds by letting n_{cur} be the next node in the post-order traversal of T_{sys}. From block 516, the technique returns to block 508. Accordingly, blocks 508-516 can be repeated until the traversal of the entire tree is complete, and the weighted net contribution of every participant has been calculated. The results can be returned to the process illustrated by FIG. 3, and used in calculating reward amounts. Specifically, portions of an available reward may be calculated as being proportional to each participant's weighted net contribution.

Note that the illustrated method 500 can be implemented as a recursive function that is called first for the root, and which recursively calls itself for calculations regarding descendent subsets.

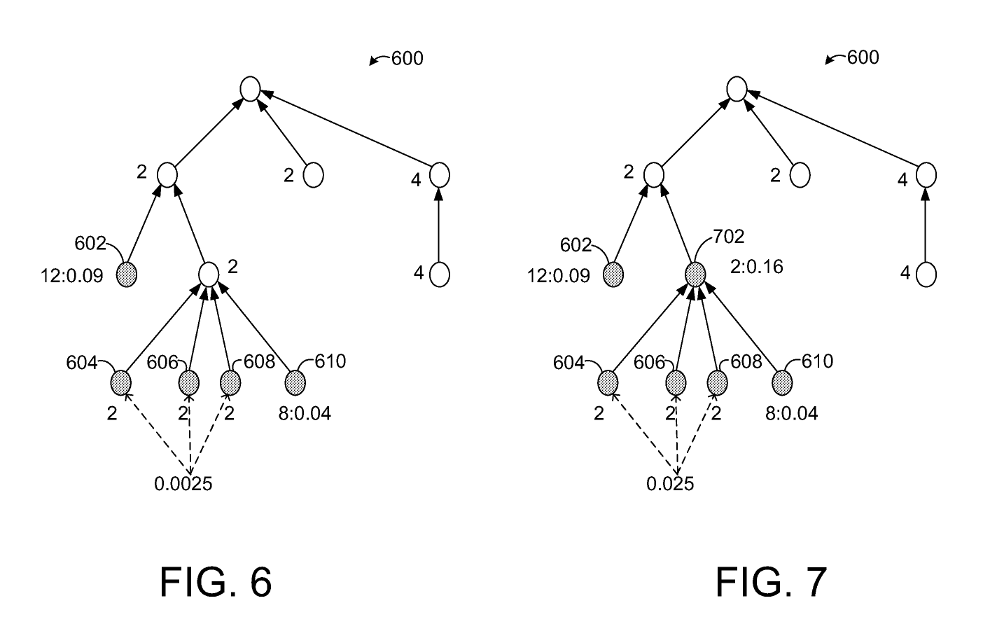

FIGS. 6-9 collectively present an example of computing weighted net contributions L(n) in accordance with the described techniques. In this example respective individual nodes are shown with their contributions and weighted contributions (represented as “contribution: weighted contribution”). The total system contribution C(Sys) is 40, and the function π(c) is assumed to be a square function: π(c)=c².

The first node to be computed is designated generally at 602 and has a contribution of 12. This node's weight is π(12/40)=0.09 and because this node has no children, this is also its weighted net contribution L(n). So in this case, the node is designated with “12:0.09”, indicating its direct contribution and its weight. The next node to be considered in the post-order traversal is the left-most leaf-node with contribution 2 designated generally at 604. This node's weight is π(2/40)=0.0025 and again because it does not have any children of its own, this also corresponds to this node's weighted net contribution. The same also holds for its two siblings designated at 806, 808 that also have a contribution of 2. These two nodes are the next to be considered in the post-order traversal. Finally, the fifth step of the post-order traversal considers the node with contribution 8 designated at 610. Doing the same calculation as above reveals that this node 610 has a weighted contribution of L(n)=π(8/40)=0.04. FIG. 6 shows the situation after these first five steps of the post-order traversal. (Grey nodes have already been computed.)

FIG. 7 shows the next node 702 to be considered is the inner node with contribution 2 that has four children (604, 606, 608, and 610 with respective contributions 2,2,2,8). The weight of this node's subset is W(Tₙ)=π((2+2+2+2+8)/40)=π(16/40)=0.16. In order to compute the weighted net contribution of this participant, the technique subtracts the weights of all child nodes or subtrees from this value. In this case, this yields

L(n)=0.16−0.0025−0.0025−0.0025−0.04=0.1125

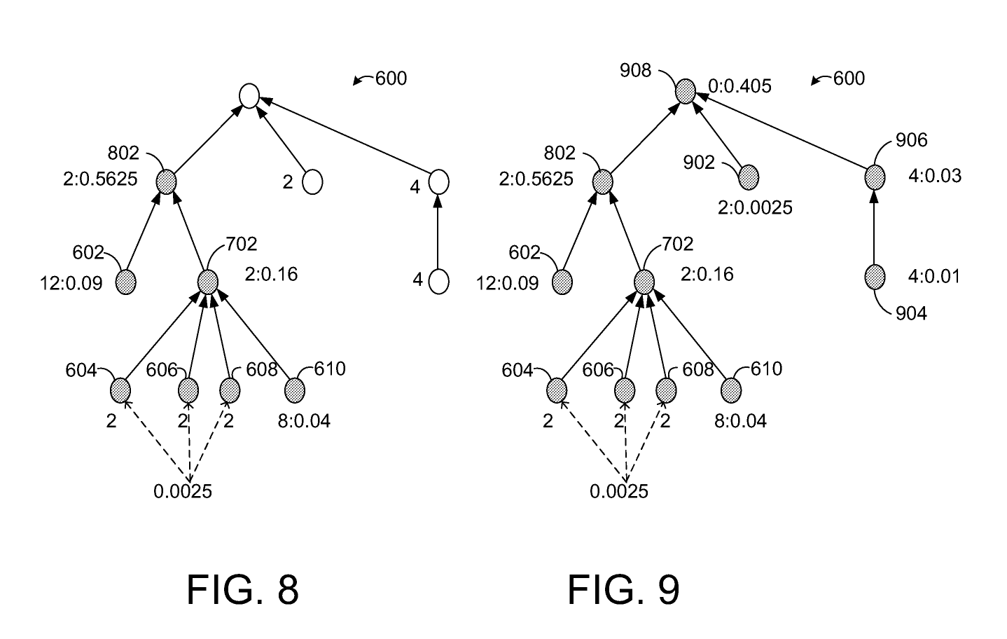

FIG. 8 shows the situation after the computation described above in relation to node 802. Notice that although this participant's contribution is 2 like one of its children, its weighted net contribution is higher, because of the “bonus” received for soliciting two children and four grandchildren. The total contributions of this node are 30. Therefore, the weight of the node's subset is W(Tₙ)=π(30/40)=0.5625. Again, the technique can use this weight to compute the weighted net contribution of node 1002 by subtracting the weights of its two child subtrees:

L(n)=0.5625−0.09−0.16=0.3125

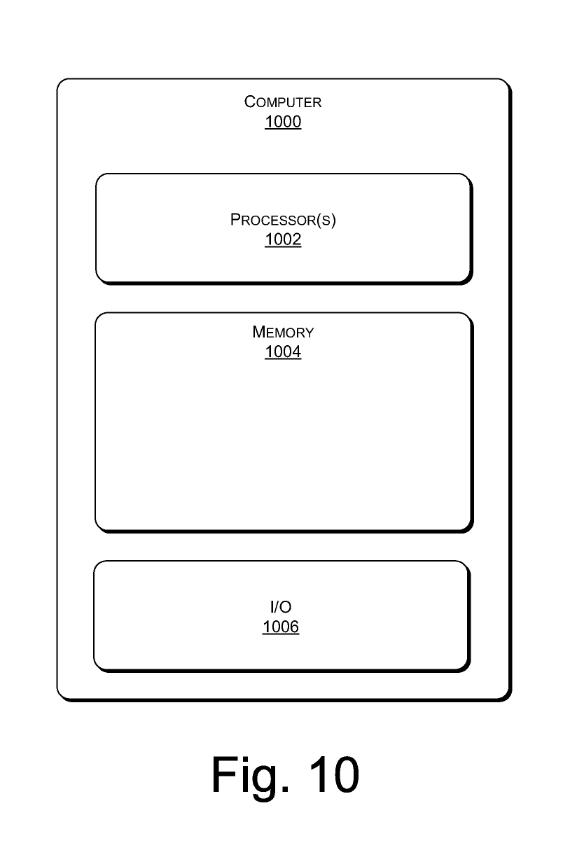

FIG. 9 shows the situation after the computation described above in relation to FIG. 8. In this case, the next node will be the leaf node 902 with contribution 2, followed by the leaf node 904 with contribution 4, then its parent node 906 with contribution 4. The computation follows the same proceedings described above and the final outcome of this computation can be seen in FIG. 9 with nodes 902, 904, and 906 having expected values of 0.0025, 0.01, and 0.03, respectively.

Note that the root 908, which corresponds to the executive entity, will be assigned a net weight when using this procedure. The root 908 has no actual contribution, but has a calculated weighted net contribution of 0.405 due to its attributed referrals. For purposes of calculating reward amounts, the root's weighted net contribution may be ignored.

It certain situations it might be beneficial to convey to participants information about what part of their rewards came from their direct contribution versus what part came from contributions by their referrals. The participant's non-referral reward can be calculated as the participant's weighted contribution multiplied by the total reward for all participants. The participant's referral reward can be defined as the participant's total reward minus the participant's non-referral reward.

FIG. 10 shows relevant high-level components of a computer 1000, as an example of various types of computing equipment that may be used to implement the techniques described above. The web service 102, for example, may be implemented by one or more physical instances of the computer 1000. More specifically, one or more instances of the computer 1000 may be used to implement different portions of the functionality of the web service 102, such as the primary services 106, the relationship tracking 110, the participation logging 112, and other functional components.

The computer 500 may comprise one or more processors 1002 and computer-readable memory 1004. The techniques described above may be implemented as software residing within the computer-readable memory 1004, such as one or more programs, modules, or routines, comprising sets or sequences of instructions that reside in the memory 1004 for execution by the one or more processors 1002.

The memory 1004 is an example of computer-readable media. Computer-readable media includes at least two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The computer 1000 may also have input/output facilities 1006 such as network interfaces, user interfaces, and so forth.

Software used to implement the techniques described above may reside in the memory 1004 as shown, and/or may also be stored and distributed in various ways and using different means, such as by storage on different types of computer-readable memory 1004, including portable and removable media. The software may also be distributed by transmission from a repository, using a data network or other types of data computer communication systems.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media comprising computer-executable instructions that, when executed by a computer, perform actions comprising:
summing a participant's contribution and the contributions of descendent participants of the participant to identify the participant's effective contribution;
applying a convex function to the participant's effective contribution to identify the participant's weighted contribution;
subtracting the weighted contributions of child participants of the participant from the participant's weighted contribution to identify the participant's weighted net contribution; and
distributing a reward to the participant, wherein the size of the reward is determined at least in part by the weighted net contribution of the participant.

2. The one or more computer-readable media of claim 1, wherein the summing includes the contributions of all of the descendent participants of the participant.

3. The one or more computer-readable media of claim 1, wherein the convex function comprises a square function.

4. The one or more computer-readable media of claim 1, wherein the convex function comprises an exponential function.

5. The one or more computer-readable media of claim 1, wherein the reward comprises financial compensation.

6. The one or more computer-readable media of claim 1, wherein the reward comprises payment to the participant.

7. A method of promoting a web-based service, comprising:
tracking referrals made by participants in the service;
quantifying contributions of the participants with respect to the web-based service;
identifying a participant subset corresponding to a particular participant, wherein the participant subset includes the particular participant and all other participants referred by any members of the participant subset;
calculating the particular participant's weighted contribution based at least in part on the quantified contributions of the participant subset corresponding to the particular participant;
calculating the particular participant's weighted net contribution based at least in part on the particular participant's weighted contribution minus the weighted contributions of collections of other participants within the participant subset corresponding to the particular participant; and
granting a reward to the participant, wherein the size of the reward is based at least in part on the particular participant's weighted net contribution.

8. The method of claim 7, wherein calculating the particular participant's weighted contribution is further based at least in part on a convex function of the quantified contributions of the participant subset corresponding to the particular participant.

9. The method of claim 7, wherein calculating the particular participant's weighted contribution is further based at least in part on an exponential function of the quantified contributions of the participant subset corresponding to the particular participant.

10. The method of claim 7, wherein calculating the particular participant's weighted contribution is further based at least in part on a squared function of the quantified contributions of participant subset corresponding to the particular participant.

11. The method of claim 7, wherein calculating the particular participant's weighted contribution is further based on a convex function of the ratio of (a) the quantified contributions of participant subset corresponding to the particular participant and (b) the quantified contributions of multiple participants.

12. The method of claim 7, wherein the size of the reward is proportional to the weighted net contribution of the participant.

13. A method of incentivizing participants of a participatory system, comprising:
identifying subsets of the participants, wherein each subset includes all participants referred by members of that subset;
distributing portions of a reward to participants based on contributions by the participants;
wherein the portion of the reward distributed to a particular participant is determined by the contributions of the participants of a corresponding one of the subsets of which the particular participant is the head; and
wherein a total of portions distributed to any given subset of participants is determined strictly by the contributions of the participants of the given subset.

14. The method of claim 13, further comprising:
determining a fractional contribution of each participant based at least in part on the contributions of an individual subset of the participants of which the participant is the head; and
applying a convex function to each participant's fractional contribution to identify a weighted contribution of the participant.

15. The method of claim 13, further comprising:
applying a convex function to the contribution of an individual subset of the participants of which the participant is the head to identify a weighted contribution of the participant; and
subtracting the weighted contribution of each participant's child participants from the participant's weighted contribution to identify a weighted net contribution of the participant.

16. The method of claim 13, further comprising summing the participation of an individual subset of the participants to identify an effective contribution of a participant at the head of the individual subset.

17. The method of claim 13, further comprising:
summing the participation of an individual subset of the participants to identify an effective contribution of a participant at the head of the individual subset;
applying a convex function to each participant's effective contribution to identify a weighted contribution of the participant;
subtracting the weighted contributions of the participant's child participants from the participant's weighted contribution to identify a weighted net contribution of the participant; and
setting the portions for individual participants in proportion to the weighted net contributions of the individual participants, respectively.

18. The method of claim 17, wherein the function is a convex function.

19. The method of claim 17, wherein the function is a square function.

20. The method of claim 17, wherein the function is an exponential function.
